(19) United States
(12) Patent Application Publication
(10) Pub. No.: US 2013/0228293 A1
(43) Pub. Date: Sep. 5, 2013

(54) SLIDING FABRIC DOOR SYSTEM FOR WARDROBES AND THE LIKE

(71) Applicant: NEATFREAK GROUP INC., Mississauga (CA)

(72) Inventors: Bertrand BARRE, Lapeyrouse (FR); Francis LEPAGE, Dommartin (FR)

(73) Assignee: NEATFREAK GROUP INC., Mississauga (CA)

(21) Appl. No.: 13/774,291

(22) Filed: Feb. 22, 2013

Related U.S. Application Data
(60) Provisional application No. 61/606,096, filed on Mar. 2, 2012.

(51) Int. Cl. E05D 15/08

(52) U.S. Cl. CPC E05D 15/08
USPC 160/205

(57) ABSTRACT

A wardrobe that may be sold in disassembled form and be readily assembled by a purchaser includes employs lightweight fabric doors, yet provides the fabric doors with sufficient rigidity to enable them to be slid back and forth along associated tracks. The fabric doors releasably attach to the overall wardrobe, enabling them to be removed for repair or replacement, as well as enabling the substitution of differently-colored or patterned doors in accordance with user preference. Substitution of doors of varying width are supported, again in accordance with the preference of the user.

### CROSS-REFERENCES TO RELATED APPLICATIONS

This application claims the benefit of U.S. provisional application No. 61/606,096, filed on Mar. 2, 2012, the entirety of which is hereby incorporated by reference.

### BACKGROUND OF THE INVENTION

1. Field of the Invention

The present invention relates, in general, to garment storage and, more particularly, to garment wardrobes and closets that are relatively light weight and that may be readily assembled by purchasers.

2. General Background of the Invention

Due to a shortage of built-in closet space in many homes and apartments, freestanding wardrobes have been popular for quite some time. Some freestanding wardrobes are relatively large, bulky, and expensive pieces of fine furniture. However, not all homeowners or renters want to incur the expense of obtaining this type of wardrobe. Other wardrobes are made from relatively inexpensive materials, but are often considered to be unattractive and thus unsuitable for use in the bedroom or other commonly used portions of the home, and are instead relegated to use within a basement or attic of the home.

### BRIEF SUMMARY OF THE INVENTION

The present invention is intended to provide a wardrobe that is constructed from relatively inexpensive components and capable of being sold in disassembled form, yet, when readily assembled by the purchaser, is attractive in appearance, and thus suitable for use within bedrooms and other commonly used areas of the home. As such, it is desirable for the present invention to incorporate features not commonly used in wardrobes but rather commonly used in traditional, built-in closets, such as horizontally sliding doors. Traditional sliding closet doors, however, are relatively heavy and cumbersome, particularly for a product intended to be sold in disassembled form and then readily assembled by an unskilled purchaser. The present invention instead employs lightweight fabric doors, yet provides the fabric doors with sufficient rigidity to enable them to be slid back and forth along associated tracks. Moreover, the fabric doors of the present invention releasably attach to the overall wardrobe, enabling them to be removed for repair or replacement, as well as enabling the substitution of differently-colored or differently-patterned doors in accordance with user preference. In addition, the present invention supports the substitution of doors of varying widths, again in accordance with the preference of the user.

### BRIEF DESCRIPTION OF THE SEVERAL VIEWS OF THE DRAWINGS

FIG. 1 an elevated, exploded perspective view of a first embodiment of the overall present wardrobe invention;

FIG. 2 is an elevated, exploded perspective view of the wardrobe assembly portion of the first embodiment of the invention;

FIG. 3A is a top perspective view of the wardrobe rail of the first embodiment of the invention;

FIG. 3B is a side view of the wardrobe rail of the wardrobe rail of the first embodiment of the invention;

FIG. 3C is a top plan view of the wardrobe rail of the wardrobe rail of the first embodiment of the invention, partially in section.

FIG. 4A is a front perspective view of a sliding rail assembly of the first embodiment of the invention; FIG. 4B is a front view of the sliding rail of a sliding rail assembly of the first embodiment of the invention;

FIG. 4C is a front perspective view of the sliding rail of the first embodiment of the invention;

FIG. 4D is a side view of two adjacent sliding rails of the first embodiment of the invention and showing, in particular, their relative horizontal spacing upon assembly of the first embodiment of the invention;

FIG. 4E is a front view of a wheel portion of a sliding rail assembly of the first embodiment of the invention;

FIG. 4F is a side sectional view of the wheel portion, taken generally along lines 4F-4F of FIG. 4E;

FIG. 5 is an elevated, exploded perspective view of the door assembly portion of the first embodiment of the invention;

FIG. 6A is a side view of a single wardrobe rail of a second embodiment of the invention;

FIG. 6B is a side view of the single wardrobe rail of FIG. 6A, showing, in particular, the operable positioning of a rolling slider relative to the single wardrobe rail;

FIG. 6C is a side view of a double wardrobe rail of a third embodiment of the invention;

FIG. 6D is a side view of the double wardrobe rail of FIG. 6C, showing, in particular, the operable positioning of two rolling sliders relative to the double wardrobe rail;

FIG. 6E is a combination front view and side view of a wheel of the rolling sliders of FIGS. 6B and 6D;

FIG. 6F is a front view of the rolling slider of the second and third embodiments of the invention;

FIG. 6G is a side view of the rolling slider of the second and third embodiments of the invention and showing, in particular, the use of spacers to provide separation of the wheels and body of the rolling slider;

FIG. 6H is an exploded perspective view of a rolling slider and associated rail and showing, in particular, the attachment member portion of the rolling slider;

FIG. 6I is a side perspective view of two rolling sliders within a common wardrobe rail;

FIG. 6J is a side view of the top portion of a sliding door assembly of the present invention and showing, in particular, the placement of an attachment member and top stiffening member thereof;

FIG. 6K is a front perspective view of a wardrobe rail of the second embodiment of the present invention and showing, in particular, the releasable attachment of the door assembly to rolling sliders carried by the wardrobe rail

FIG. 7A is an exploded perspective view of an alternative embodiment of a dual wardrobe rail and sliding rail assembly; and

FIG. 7B is an enlarged front view of the wardrobe rail of FIG. 7A.

### DETAILED DESCRIPTION OF THE INVENTION

While the present invention is susceptible of embodiment in many different forms, there is shown in the drawings and will herein be described in detail, several specific embodiments, with the understanding that the present disclosure is intended as an exemplification of the principles of the present invention and is not intended to limit the invention to the embodiments illustrated.

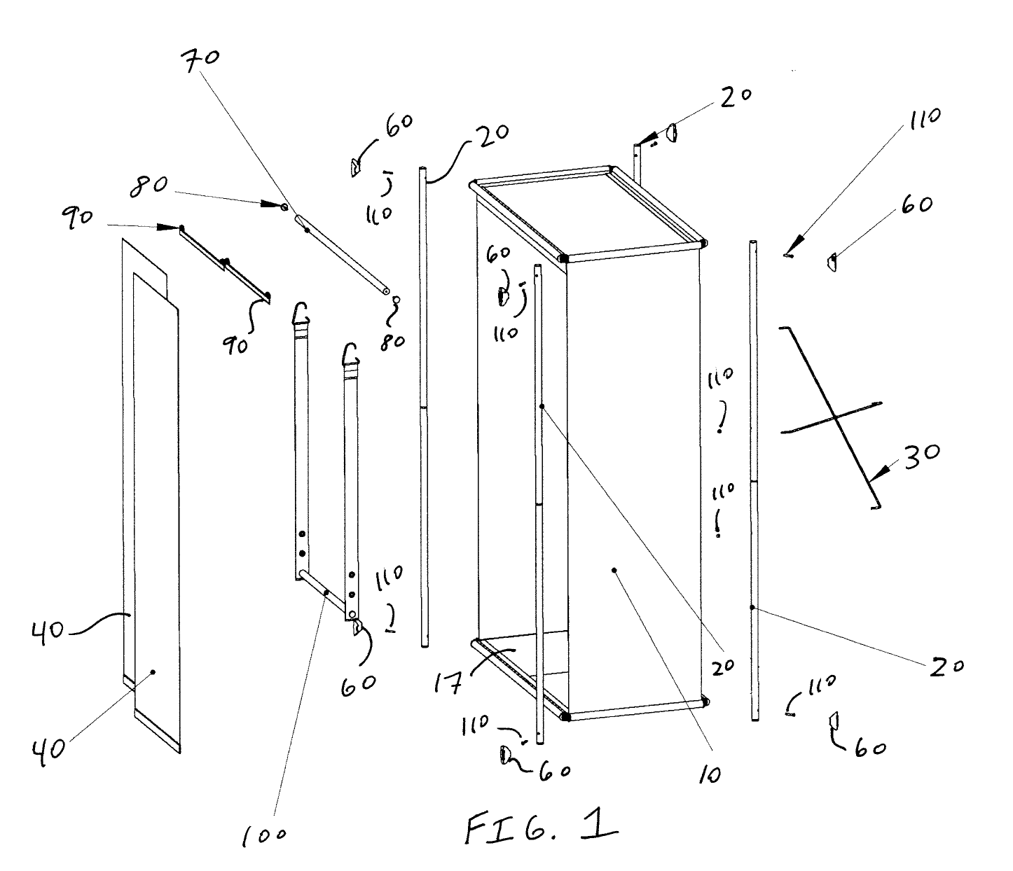

As shown in FIG. 1, a first embodiment of the present invention is shown as comprising wardrobe assembly 10, a plurality of vertical tube assemblies 20, X-frame assembly 30, a plurality of door assemblies 40, a plurality of corner bracket caps 60, garment hang bar 70, hang bar end caps 80, a plurality of rail slide assemblies 90, double hanging bar assembly 100, and a plurality of fasteners 110. Fasteners 110 may comprise, for example, M6×35 mm hex head screws, or any other suitable fastener that preferably facilitates assembly of the present invention by the purchaser using only simple hand tools that may be either supplied with the disassembled wardrobe, or that are commonly found in the home. Garment hang bar 70 may constructed from steel tubing having a wall thickness of approximately 0.7 mm. X-frame assembly 30 may be constructed from 6 mm steel rods and attaches to the back of wardrobe assembly 10 across two opposing vertical tube assemblies 20, thereby providing stiffness and rigidity the frame components of wardrobe assembly 10.

As shown in FIG. 2, wardrobe assembly 10 comprises wardrobe body 11, wardrobe rail 120, a plurality of first wardrobe tubes 12, a plurality of second wardrobe tubes 13, a plurality of corner brackets 14, a plurality of grommets 15, and a plurality of fasteners 110. The outer side, top, bottom, and back surfaces or wardrobe body 11 are all preferably constructed of a relatively strong fabric material, such as a 600 dernier polyester material. Eight sleeves 16 are formed within wardrobe body 11 proximate the top and bottom surfaces thereof to accommodate the insertion of associated first wardrobe tubes 12 and second wardrobe tubes 13, which are secured in place by corner brackets 14 and fasteners 110. Each sleeve is preferably constructed of the same fabric material as the overall wardrobe body. First wardrobe tubes 12 and second wardrobe tubes 13 may be constructed from steel tubing having a wall thickness of approximately 0.7 mm, and corner brackets 14 may likewise be constructed of a steel material.

As shown in FIG. 1, corner brackets 14 also receive associated vertical tube assemblies 20, likewise secured in place by fasteners 110. A rigid board material 17 is preferably affixed adjacent the inside top and bottom surfaces of wardrobe body 11 to reinforce and provide further rigidity to these surfaces. Grommets 15 are placed through nylon reinforcing webbing disposed on opposing sides of the left and right side surfaces of wardrobe body 11, proximate the top surface. Double hanging bar assembly 100 includes two opposing hooks cooperating with and grommets 15 which serve as points of hanging attachment, permitting the assembly to be suspended from grommets 15 within the interior of wardrobe body 11. As described in detail below, each door assembly 40 is releasably attachable to an associated rail slide assembly 90.

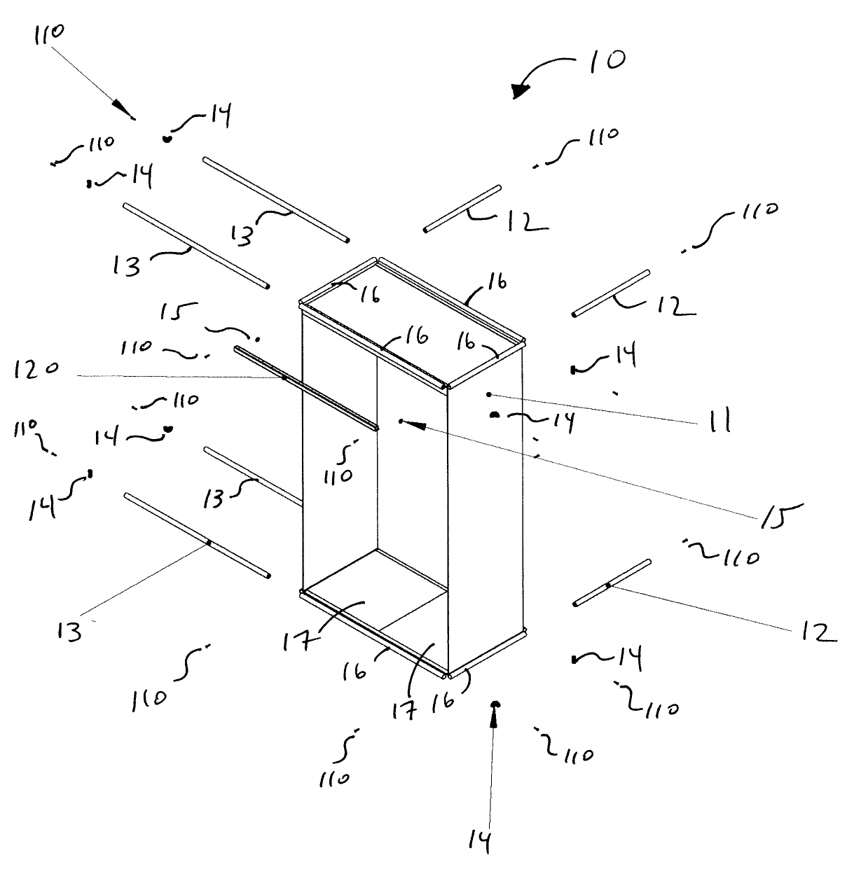

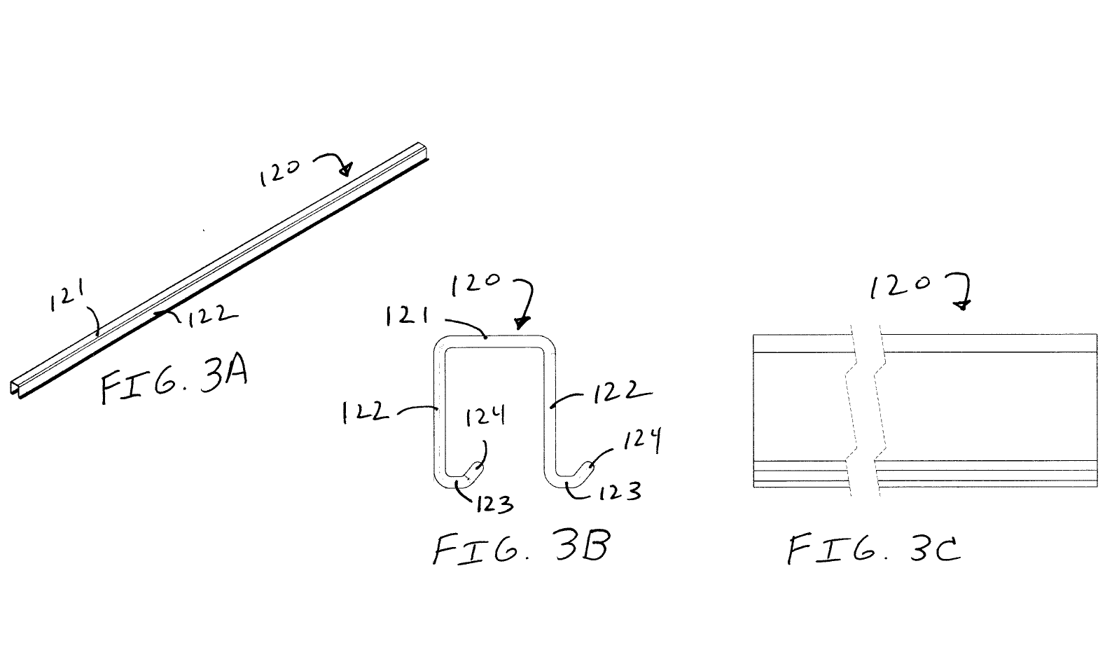

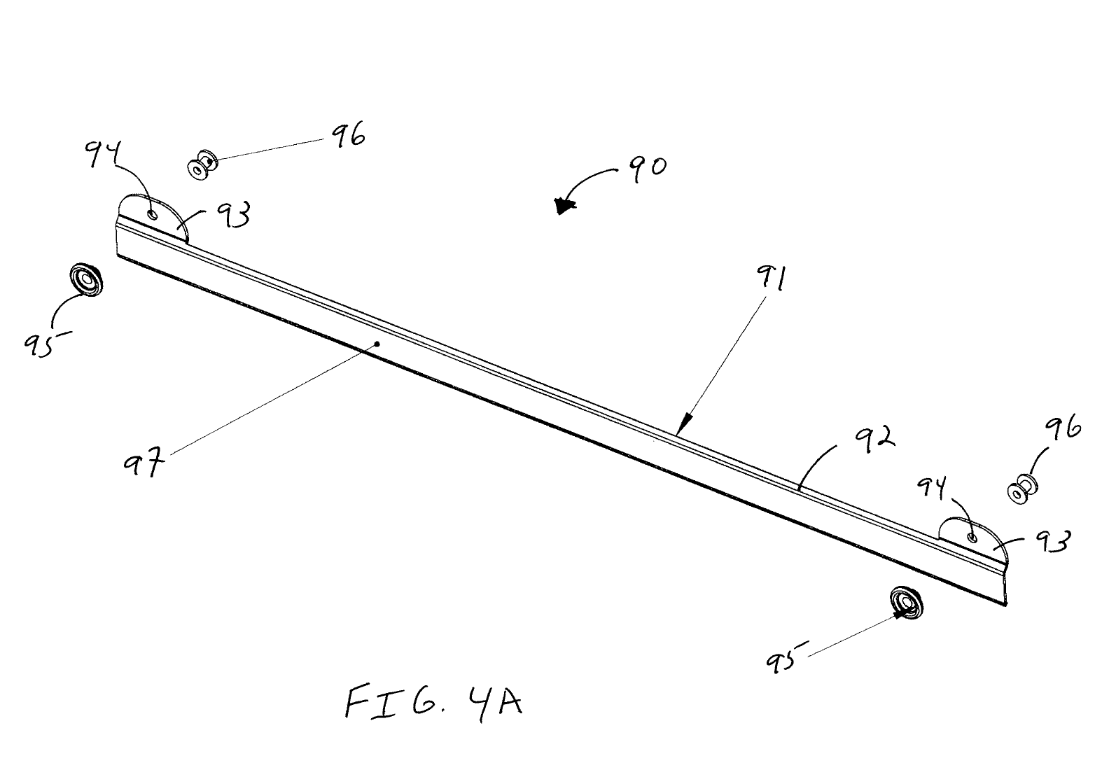

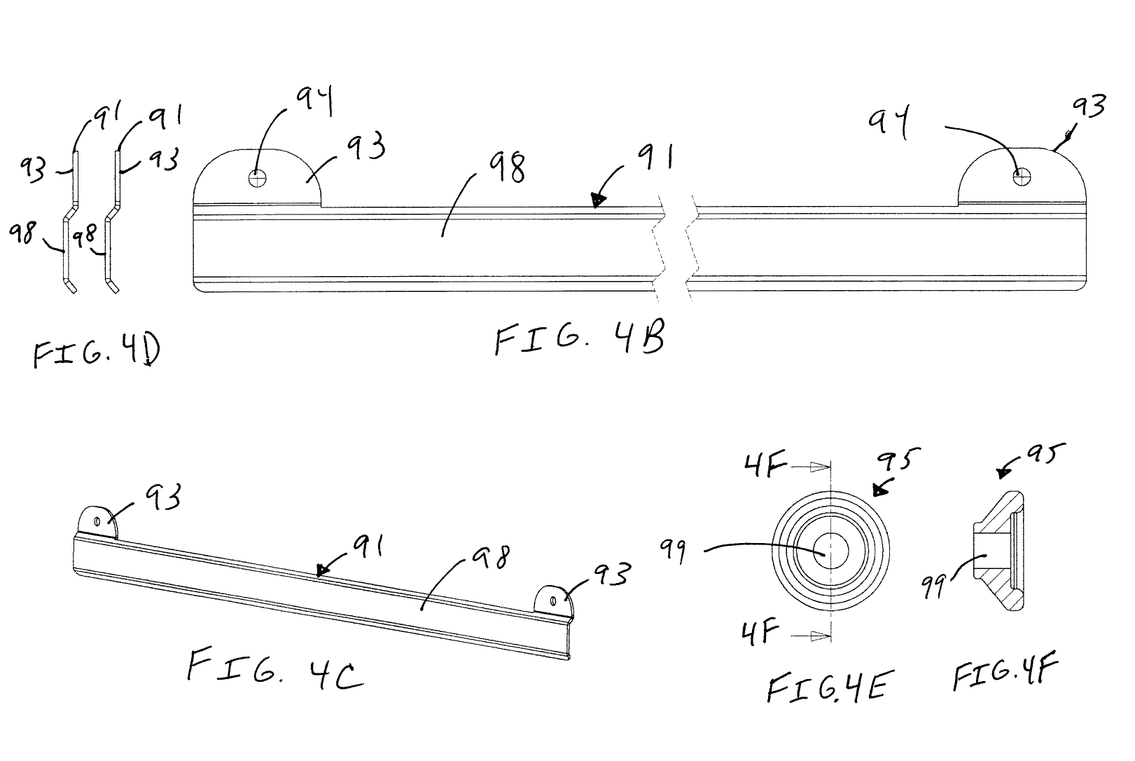

As shown in FIGS. 3A through 3C, wardrobe rail 120 comprises horizontal portion 121 and two vertical arms 122. Each vertical arm 122 terminates in a hooked region, formed by horizontal roller support portion 123 and roller retaining portion 124. Wardrobe rail 120 may be constructed of a rigid polyvinylchloride (“PVC”) material. As shown in FIGS. 4A through 4F, each rail slide assembly 90 comprises door glide rail member 91, a plurality of wheels 95 and a plurality of tubular rivets 96. Each rivet 96, in cooperation with an associated aperture 94 of a tab region 93 of door glide rail member 91, and an associated aperture 99 of wheel 95, serves to rotatably affix a wheel 95 adjacent the front surface of glide rail member 91, with a cylindrical shaft region of each rivet serving as both an axle and a bearing for an associated wheel 95, about which wheels 95 may freely rotate. As best seen in FIGS. 4D and 4A, each glide rail member 91 includes an elongated raised region 98, providing a planar, elongated rectangular surface for attachment of releasable fastening member 97. In a preferred embodiment, releasable fastening member 97 comprises either the male (i.e., hook) or female (i.e., loop) half of a combination hook-and-loop fastener of relatively strong (yet releasable) bonding strength, such as a VELCRO® brand fastener, and is sized to substantially overlie elongated raised region 98. A suitable adhesive may be employed to securely bond releasable fastening member 97 to elongated raised region 98.

Each rail slide assembly 90 is slidably coupled to an associated vertical arm 122 of wardrobe rail 120 by positioning both associated wheel members 95 atop horizontal roller support portion 123, adjacent roller retaining portion 124. Horizontal roller support portion 123 accordingly serves as an elongated track, accommodating wheel members 95 to, in turn, permit back-and-forth sliding of door glide rail member 91 relative to wardrobe rail 120.

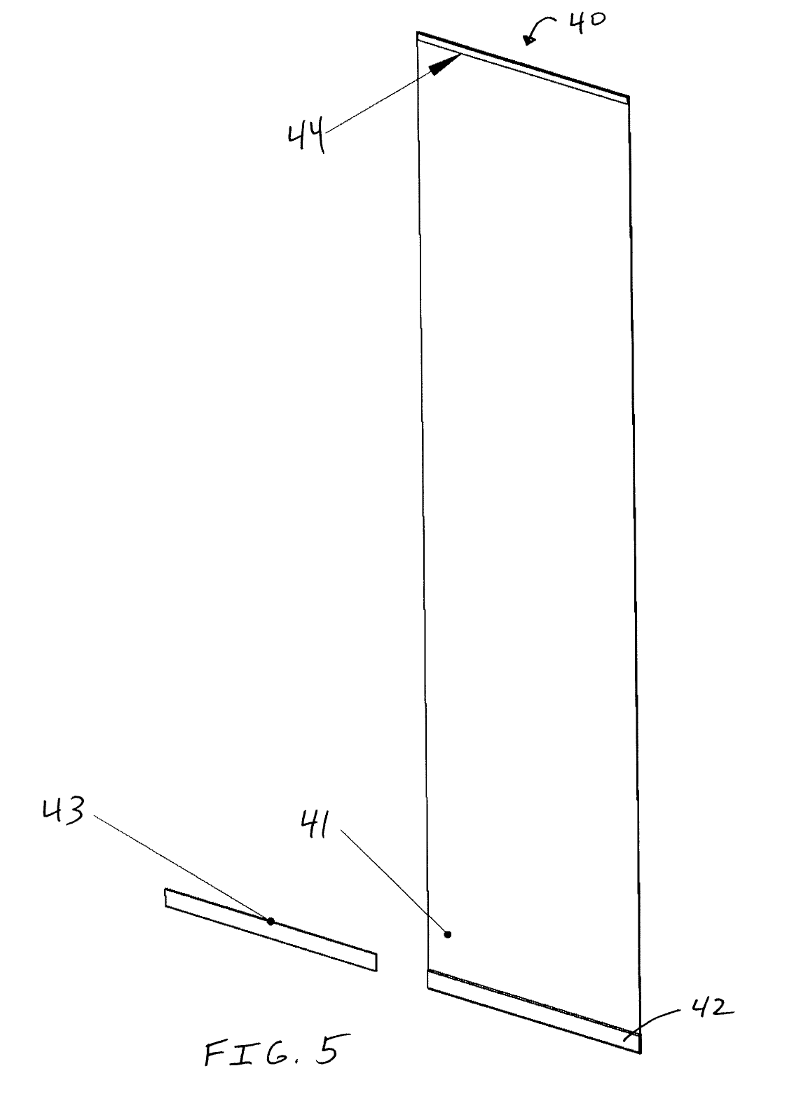

As shown in FIG. 5, in a first embodiment of the present invention, each door panel assembly includes door panel 41, having bottom sleeve 42 extending along the entire width of the bottom edge thereof. Bottom weight, which may comprise an elongated rectangular bar of steel or aluminum, may be inserted into bottom sleeve 42 through an aperture disposed at least one end of bottom sleeve 42. Releasable fastening member 44 extends along substantially the entire top edge of one side of door panel 41. In a preferred embodiment, releasable fastening member 44 comprises either the male or female half of a combination hook-and-loop fastener of relatively strong bonding strength, such as a VELCRO® brand fastener. A suitable adhesive or stitching may be employed to securely bond releasable fastening member 44 to door panel 41. Door panel 41 may be constructed of a relatively lightweight fabric material, such as a 300 dernier polyester material.

Releasable fastening member 44 of door assembly 40 and releasable fastening member 97 of rail slide assembly 90 collectively form the male and female portions of a hook-and-loop fastener, and serve to releasably attach the top edge region of door panel 41 to raised region of 98 of door glide rail member 91. This, in turn, permits each door panel 41 to slide back and forth proximate the front opening of wardrobe body 11, as rail slide assembly 90 is slid back and forth by rolling wheel members 95 along the upper surface of horizontal roller support portion 123 of wardrobe rail 120.

The releasable attachment of individual door assemblies 40 to associated rail slide assemblies 90 permit door assemblies 40 to be readily removed and replaced to facilitate their cleaning or repair. Moreover, the ease of replacement of door assemblies 40 permits any door panel 41 to be rapidly replaced with one of another color, pattern, and/or size, depending upon the user's preference.

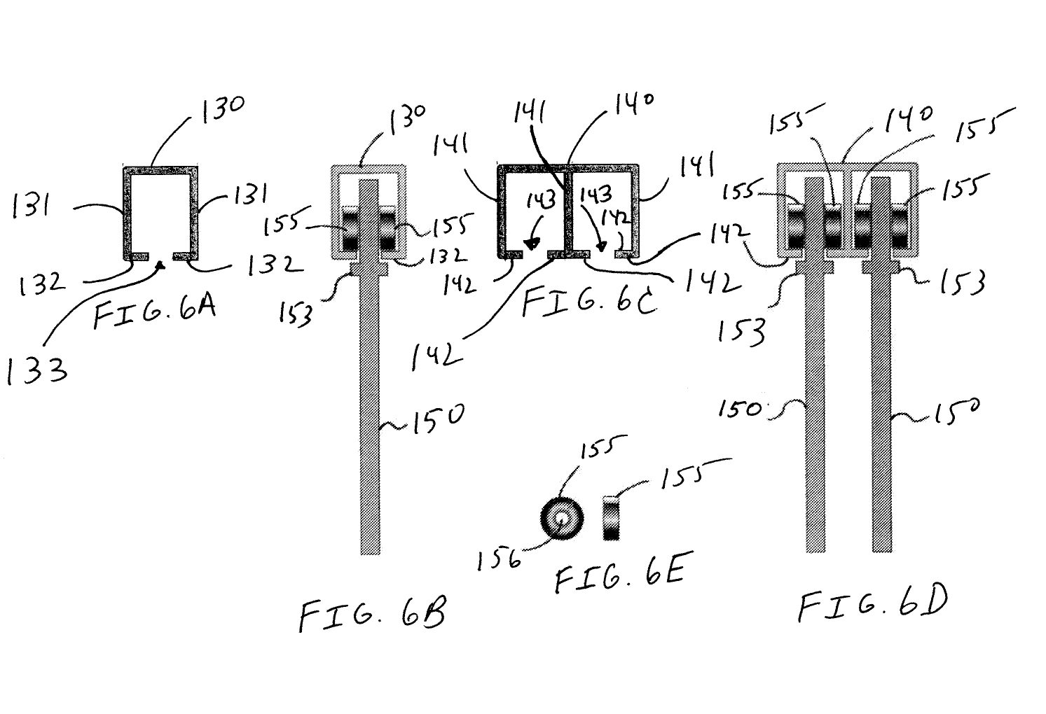

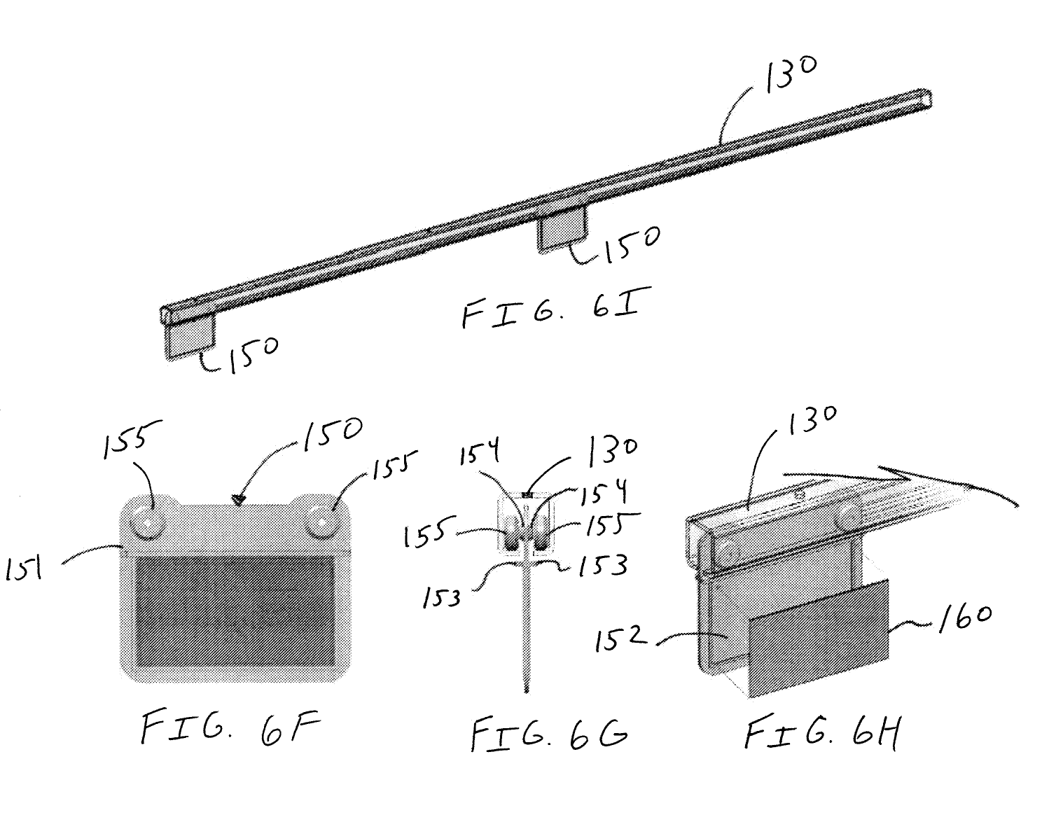

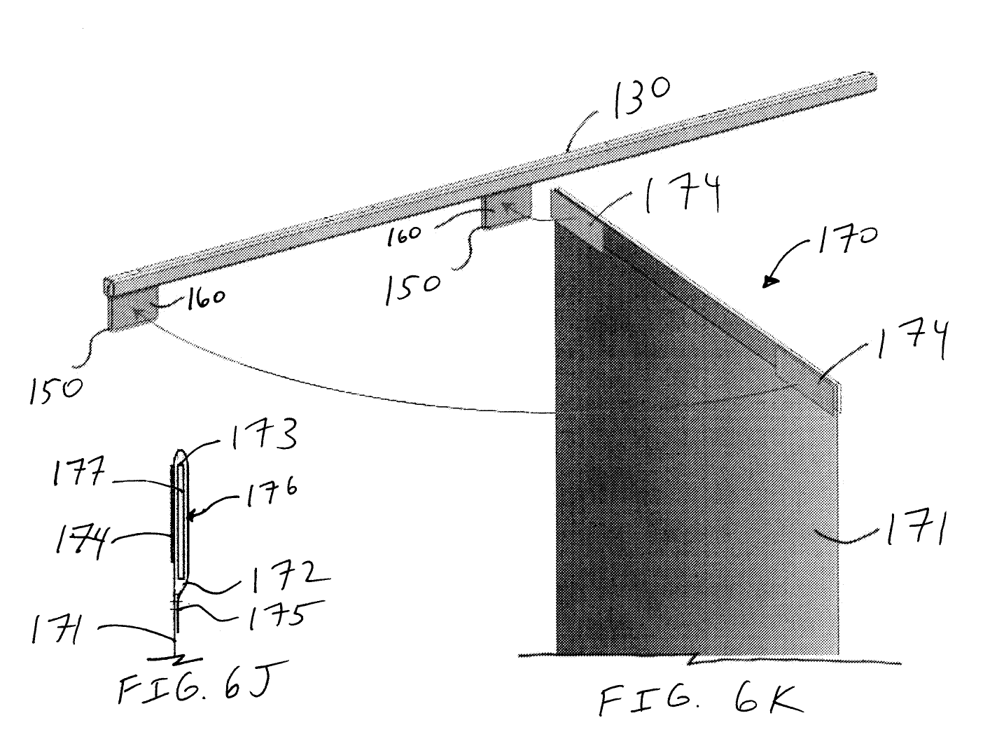

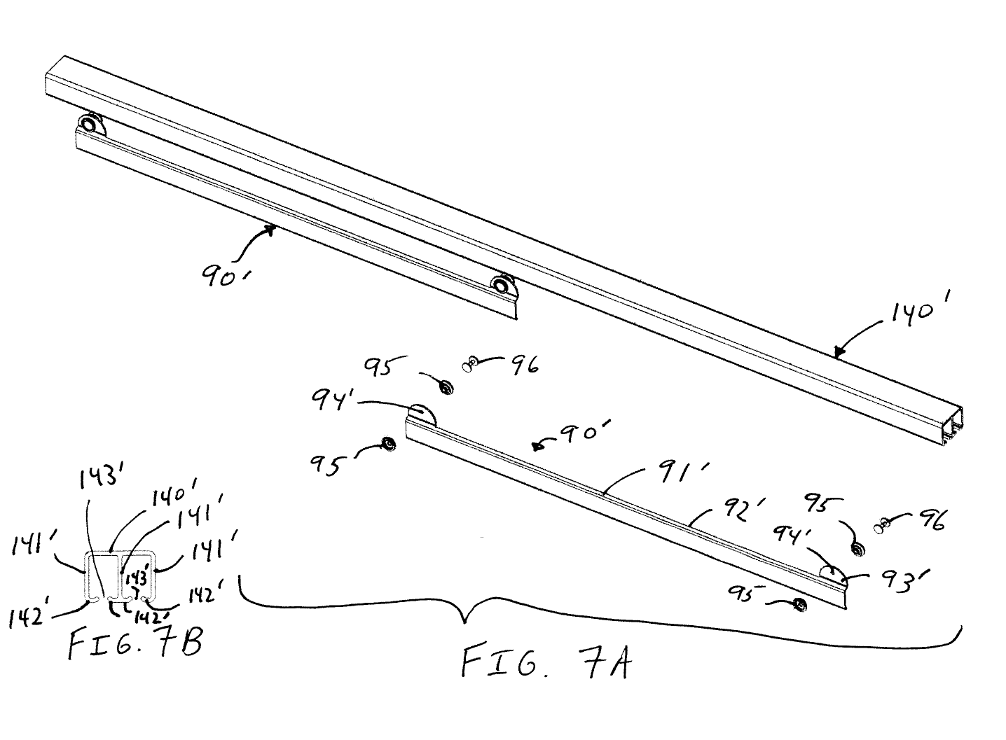

Second and third embodiments of the present invention are shown in FIGS. 6A through 6K. FIG. 6A shows single wardrobe rail 130 of the second embodiment of the present invention as comprising vertical arms 131, horizontal legs 132, and aperture 133 disposed between opposing horizontal legs 132. FIG. 6C shows double wardrobe rail 140 of the third embodiment of the present invention as comprising three vertical arms 141, each with associated horizontal legs 142. As shown in FIG. 6C, the two outer vertical arms 141 each has one associated, inwardly-extending horizontal leg 142, while a central vertical arm 141 includes two associated horizontal legs 142, extending in opposing directions. In this manner, two bottom apertures 143 are each disposed between opposing pairs of horizontal legs 142.

As shown in FIGS. 6F through 6H, in the second and third embodiments of the present invention, door sliding member 150 comprises slider body 151, having recessed rectangular region 152 and two pairs of wheels 155. Each pair of wheels 155 are rotatably attached to opposing sides of slider body 151, proximate the top edge of slider body 151. Spacers 154 are employed between each wheel 155 and slider body 151 to facilitate each wheel's rotation. Spacers 154 may comprise separate components, or may be integrally formed, raised portions of slider body 151. Moreover, an axle extending outwardly from each spacer 154 extends through central aperture 156 of each wheel 155.

Releasable fastening member 160 is substantially rectangular in shape and is sized to fit within recessed region 152 of slider body 151. In a preferred embodiment, releasable fastening member 160 comprises either the male or female half of a combination hook-and-loop fastener of relatively strong bonding strength, such as a VELCRO® brand fastener. A suitable adhesive may be employed to securely bond releasable fastening member 160 to recessed region 152 of slider body 151.

As shown in FIGS. 6B, 6D and 6G, in the second and third embodiment of the present invention, each door sliding member 150 slidably engages an associated wardrobe rail 130 or 140, through the engagement of associated wheel members 155 atop horizontal legs 132 or 142. Crossbar members 153 of slider body 151 serve to further retain each sliding door member 150 in sliding engagement with an associated wardrobe rail 130 or 140, including inhibiting slider body 151 from rocking back and forth. As shown in FIG. 61, for each door assembly of the second and third embodiments of the present invention, at least two door sliding members 150 slidably engage a wardrobe rail 130 (or 140).

As shown in FIG. 6J and 6K, door assembly 170 includes door panel 171 having top sleeve 176 extending along the entire width of the top edge thereof. Top sleeve 176 may be formed by folding a top portion 172 of door panel 171 about itself, and then stitching or otherwise attaching the top edge of the door panel 171 at seam 175, thereby creating an internal channel having end apertures 173. A stiffening member 174, which may comprise an elongated rectangular bar or steel or aluminum, and extending along substantially the entire width of door panel 171, is inserted through aperture 173 and carried within top sleeve 176.

As shown in FIGS. 6J and 6K, substantially rectangular releasable fastening members 174 are disposed at opposing top inside corners of door panel 171. In a preferred embodiment, each releasable fastening member 174 comprises either the male or female half of a combination hook-and-loop fastener of relatively strong bonding strength, such as a VELCRO® brand fastener. A suitable adhesive or stitching may be employed to securely bond releasable fastening member 174 to door panel 171.

As shown in FIG. 6K, releasable fastening member 174 of door assembly 170 and releasable fastening member 160 of door sliding member 150 collectively form the male and female portions of a hook-and-loop fastener, and serve to releasably attach the top edge region of door panel 171 to two door sliding members 150. This, in turn, permits each door panel 171 to slide back and forth proximate the front opening of wardrobe body 11, as door sliding members 150 are slid back and forth by rolling wheel members 155 along the upper surface of horizontal legs 132 or 142 of wardrobe rail 130 or 140, respectively.

The use of a plurality of individual door sliding members 150, which are individually slidable within an associated rail member, permits door panels 171 of varying widths to be readily accommodated, as the distance between door sliding members 150 can be adjusted to accommodate a particular desired width of door panel 171. Moreover, as in the first embodiment of the present invention, the releasable attachment of individual door sliding members to door assemblies 170 permits door assemblies 170 to be readily removed and replaced to facilitate their cleaning or repair, or to accommodate the color, pattern, or size preference of the user.

An alternative embodiment of a dual wardrobe rail and sliding rail assembly is shown in FIGS. 7A and 7B as including rail slide assembly 90′, which is somewhat similar in construction to rail slide assembly 90 as described above, but which includes four, rather than two, associated wheels; and double wardrobe rail 140′, which is somewhat similar in construction to double wardrobe rail 140, as described above. In particular, each rail slide assembly 90′ comprises door glide rail member 91′, four wheels 95 and two tubular rivets 96. Each rivet 96, in cooperation with an associated aperture 94′ of a tab region 93′ of door glide rail member 91′, and associated apertures of a pair of wheels 95, serves to rotatably affix a pair of wheels 95 adjacent opposing sides of the front surface of glide rail member 91′, with a cylindrical shaft region of each rivet serving as both an axle and a bearing for two associated wheels 95, about which wheels 95 may freely rotate.

With continuing reference to FIGS. 7A and 7B, double wardrobe rail 140′ of this embodiment of the present invention is shown as comprising three vertical arms 141′, each with associated horizontal legs 142′. As best seen in FIG. 7B, the two outer vertical arms 141′ each has one associated, inwardly-extending horizontal leg 142′, while a central vertical arm 141′ includes two associated horizontal legs 142′, extending in opposing directions. In this manner, two bottom apertures 143′ are each disposed between opposing pairs of horizontal legs 142′.

Many modifications and variations of the present invention are possible in light of the above teachings. It is therefore to be understood that within the scope of the appended claims, the invention may be practiced other than as specifically described. Various modifications, changes and variations may be made in the arrangement, operation and details of performing the various steps of the invention disclosed herein without departing from the spirit and scope of the invention. The present disclosure is intended to exemplify and not limit the invention.

What is claimed is:

1. A sliding wardrobe door system, comprising:
at least one substantially flexible door having a top edge and a bottom edge;
at least one stiffening member disposed proximate the top edge of one of the at least one substantially flexible door;
a first releasable fastening member disposed proximate the top edge of one of the at least one substantially flexible door;
at least one sliding member having a second releasable fastening member, the first releasable fastening member and the second releasable fastening member cooperating to provide releasable attachment of the at least one door to the sliding member; and
at least one rail member having an elongated track, the at least one sliding member being operably coupled to the at least one rail member to permit the door to slide back and forth along the track.

2. The invention according to claim 1, wherein the at least one first releasable fastening member comprises one of a male hook-and-loop fastener and a female hook-and-loop fastener.

3. The invention according to claim 1, wherein the at least one second releasable fastening member comprises one of a male hook-and-loop fastener and a female hook-and-loop fastener.

4. The invention according to claim 1, wherein the at least one sliding member comprises at least two sliding members, each of the at least two sliding members being separately releasably attachable to the at least one door.

5. The invention according to claim 1, further comprising at least one wheel operably coupled to at least one of the at least one sliding members.

6. The invention according to claim 1, wherein the at least one door comprises at least two substantially flexible doors, each of the at least two substantially flexible doors being releasably attachable to at least one sliding member to, in turn, slidably engage an associated one of the at least one rail member.

7. The invention according to claim 1, wherein the at least one rail member is disposed proximate a top opening of a wardrobe body.

8. The invention according to claim 7, wherein the wardrobe body is constructed of a substantially flexible material.

9. The invention according to claim 1, further comprising a weight coupled proximate a bottom portion of the at least one door.
